(19) United States
(12) Patent Application Publication
(10) Pub. No.: US 2026/0072388 A1
(43) Pub. Date: Mar. 12, 2026

(54) SHEET CONVEYANCE APPARATUS AND IMAGE FORMING APPARATUS

(71) Applicant: CANON KABUSHIKI KAISHA, Tokyo (JP)

(72) Inventor: AKIRA MATSUSHIMA, Shizuoka (JP)

(21) Appl. No.: 19/322,078

(22) Filed: Sep. 8, 2025

(30) Foreign Application Priority Data
Sep. 11, 2024 (JP) 2024-157526

(51) Int. Cl. G03G 15/00; G03G 15/16; G03G 21/16

(52) U.S. Cl. CPC G03G 15/6561; G03G 15/1615; G03G 15/6511; G03G 21/1633; G03G 21/1647; G03G 2215/00556; G03G 2221/1657

(57) ABSTRACT

A sheet conveyance apparatus includes a conveyance roller pair that forms a nip portion and a conveyance guide that is movable between a first position and a second position. The conveyance roller pair conveys a sheet nipped at the nip portion in a sheet conveyance direction. At least a part of a sheet conveyance path is opened in a state where the conveyance guide is at the second position. In a case where conveyance of the sheet is stopped after the leading edge of the sheet passes through the nip portion and before the trailing edge of the sheet passes through the nip potion, and in a case where the conveyance guide is moved from the first position to the second position, a moving operation of moving the sheet downstream in the sheet conveyance direction is performed by the conveyance roller pair.

### BACKGROUND

### Field of the Technology

The present disclosure relates to a sheet conveyance apparatus that conveys sheets and an image forming apparatus that forms images on sheets.

### Description of the Related Art

Japanese Patent Laid-Open No. 2001-72283 describes a technique for releasing a sheet when it is detected that this sheet is jammed while the sheet is nipped at a nip portion of a registration roller pair. In this technique, the sheet is released upstream of the registration roller pair by rotating the registration roller pair in the reverse direction.

There are cases where an image forming apparatus includes a conveyance guide that can open and close at least a part of a conveyance path downstream of a conveyance roller pair in a sheet conveyance direction. In these cases, it is suitable to improve workability of a jam clearing process performed while the conveyance guide is opened.

### SUMMARY

The present disclosure is directed to providing a sheet conveyance apparatus and an image forming apparatus that can improve workability of a jam clearing process.

According to some embodiments of the present disclosure, a sheet conveyance apparatus includes a conveyance roller pair configured to form a nip portion, the conveyance roller pair configured to convey a sheet nipped at the nip portion in a sheet conveyance direction, and a conveyance guide configured to be movable between a first position and a second position, wherein the conveyance guide at the first position forms at least a part of a sheet conveyance path downstream of the conveyance roller pair in the sheet conveyance direction, and at least a part of the sheet conveyance path is opened in a state where the conveyance guide is at the second position, wherein the conveyance roller pair is disposed upstream of a transfer portion where an image is transferred from an image bearing member to a sheet and is adjacent to the transfer portion in the sheet conveyance direction, and wherein, in a case where conveyance of a sheet is stopped after a leading edge of the sheet passes through the nip portion and before a trailing edge of the sheet passes through the nip potion, and where the conveyance guide is moved from the first position to the second position, a moving operation of moving the sheet downstream in the sheet conveyance direction is performed by the conveyance roller pair.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are sectional views illustrating a part of an image forming apparatus according to a first embodiment.

FIG. 2 is a perspective view of the image forming apparatus according to the first embodiment.

FIG. 3 is a schematic view illustrating the image forming apparatus according to the first embodiment.

FIG. 4 is a schematic view illustrating the image forming apparatus according to the first embodiment.

FIG. 5 is a schematic view illustrating a registration roller pair according to the first embodiment.

FIG. 6 illustrates a cassette that has been pulled out.

FIGS. 7A to 7C illustrate the state of a jammed sheet when the cassette is pulled out.

FIG. 8A is a control block diagram according to the first embodiment, and FIG. 8B is a flowchart illustrating a control example according to the first embodiment.

FIGS. 9A and 9B are sectional views illustrating a part of an image forming apparatus according to a second embodiment.

### DESCRIPTION OF THE EMBODIMENTS

Hereinafter, various embodiments, features, and aspects according to the present disclosure will be described with reference to the drawings.

### First Embodiment

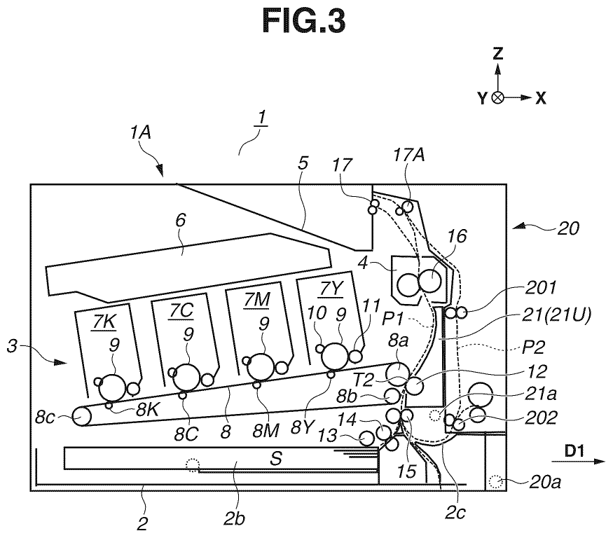

FIG. 3 is a schematic view illustrating a printer 1 according to a first embodiment of the present disclosure. The printer 1 is an example of an image forming apparatus that forms images on sheets S, each of which is a recording material (a recording medium). Various kinds of sheet materials different in size and material can be used as the sheets S. For example, paper such as plain paper and thick paper, a sheet material such as coated paper on which surface treatment has been performed, a sheet material having a special shape such as an envelope or index paper, a plastic film, cloth, etc. can be used. First, an outline of the printer 1 will be described.

In the following description and drawings, a vertical direction (a direction of the force of gravity) when the printer 1 is installed on a horizontal surface is defined as a Z-axis direction. A direction of the rotational axis of an individual photosensitive drum 9 included in the printer 1 is defined as a Y-axis direction. A direction crossing both the Z-axis direction and the Y-axis direction is defined as an X-axis direction. Suitably, the X-axis direction, the Y-axis direction, and the Z-axis direction are perpendicular to each other.

A positive direction and a negative direction of each coordinate axis direction are denoted by adding a sign “+” (plus) and “−” (minus), respectively, as desired. For example, the positive direction of the X axis (the direction indicated by an arrow X) may be referred to as the +X side, and the negative direction of the X axis (the opposite side of the arrow X) may be referred to as the −X side. As will be described below, a user can, for example, refill a cassette 2 with the sheets S, can open and close a door 20 when the user performs a jam clearing process or cartridge replacement, and can take out a product from a discharge tray 5 of the printer 1 according to the present embodiment, by accessing the printer 1 mainly from the +X side. Therefore, the +X side of the printer 1 according to the present embodiment may be referred to as a front surface side or a front side.

As illustrated in FIG. 3, the printer 1 includes an apparatus main body 1A (a main body frame), the door 20, the cassette 2, an image forming section 3 as an image forming unit, and a fixing section 4.

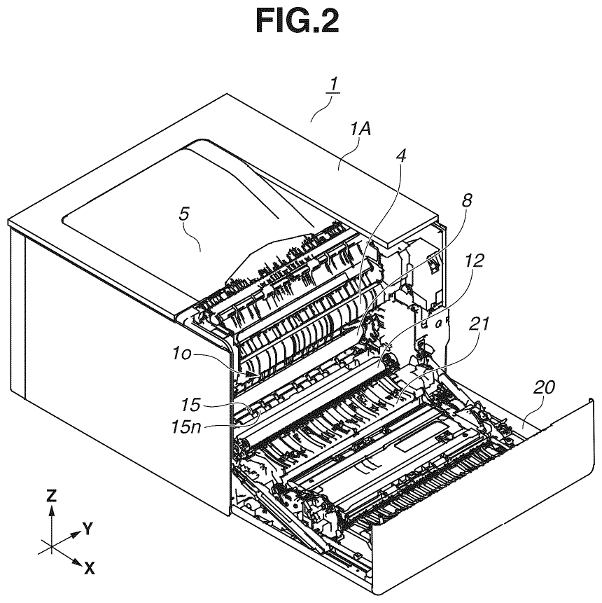

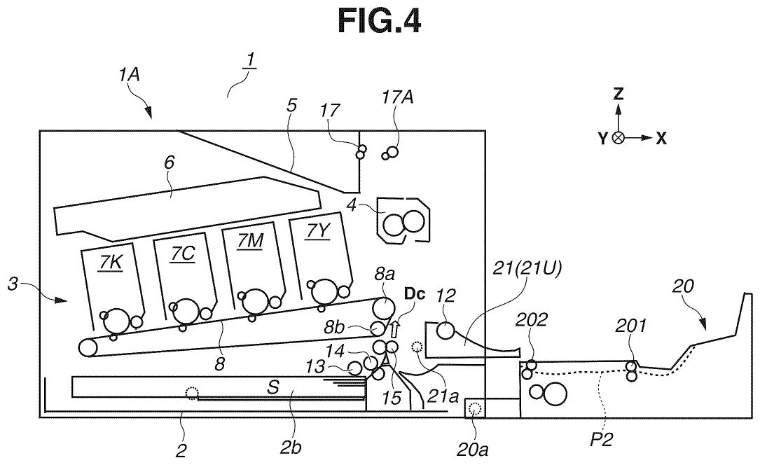

The apparatus main body 1A stores the image forming section 3 and the fixing section 4. An opening portion 1o (FIG. 2) is provided on the end surface on the +X side of the apparatus main body 1A. The opening portion 1o opens toward the downstream side in a pull-out direction D1 of the cassette 2, which will be described below. The door 20 is an opening/closing member (an opening/closing unit, a door unit) that is movable between a closed position (FIG. 3) at which the opening portion 1o is closed and an open position (FIGS. 2 and 4) at which the opening portion 1o is opened. The apparatus main body 1A and the door 20 constitute a housing of the printer 1 according to the present embodiment. The discharge tray 5 as a stacking part is provided on an upper surface part of the apparatus main body 1A. The stacking part stacks the sheet S on which an image has been formed.

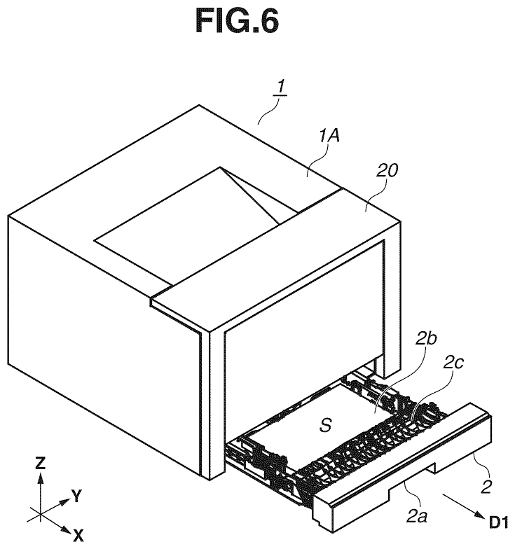

The cassette 2 is provided with a storage part 2b (a storage space) for storing the sheets S, and is attached to the apparatus main body 1A such that the cassette 2 can be pulled out in the pull-out direction D1. The pull-out direction D1 of the cassette 2 according to the present embodiment is the +X side (a front surface side) in the X-axis direction. The cassette 2 is attached to (inserted into) the apparatus main body 1A in the direction opposite to the pull-out direction D1. A gripping portion 2a (FIG. 6), which the user grips when pulling out the cassette 2, is provided at the +X side end portion of the cassette 2. The cassette 2 may include a curved guide 2c that constitutes a part of a double-sided printing path P2, which will be described below, and an in-cassette conveyance path for receiving sheets S from an optional feeding device connected to a lower part of the apparatus main body 1A.

The image forming section 3 is a four-drum full-color electrophotographic unit that includes a laser scanner 6 as an exposure part, four cartridges 7Y, 7M, 7C, and 7K, and a transfer unit. The cartridges 7Y, 7M, 7C, and 7K are process units that form toner images in respective colors of yellow (Y), magenta (M), cyan (C), and black (K) by an electrophotographic process.

The cartridges 7Y to 7K have the same configuration except for the color of their toner used as the developer. Each of the cartridges 7Y to 7K according to the present embodiment includes a photosensitive drum 9, a charging roller 10 as a charging member, a developing roller 11 as a developing member, and a toner storage part (a developing container) that stores toner.

The cartridges 7Y to 7K can be attached to and detached from the apparatus main body 1A through the opening portion 1o. The printer 1 may include a tray (a cartridge tray) that can be pulled out from the apparatus main body 1A through the opening portion 1o, and the cartridges 7Y to 7K may be attached to and detached from the apparatus main body 1A by being attached to and detached from the tray.

The transfer unit includes an intermediate transfer belt 8 as an image bearing member (an intermediate transfer member), a plurality of rollers (8a, 8b, and 8c), primary transfer rollers 8Y, 8M, 8C, and 8K, and a transfer roller 12 (a secondary transfer roller). The intermediate transfer belt 8 is stretched around a driving roller 8a, an assist roller 8b, and a tension roller 8c. The intermediate transfer belt 8 is disposed below the four cartridges 7Y, 7M, 7C and 7K. The intermediate transfer belt 8 is disposed to be in contact with the photosensitive drum 9 of each of the cartridges 7Y, 7M, 7C and 7K, and is rotated in the counterclockwise direction in the drawing by the driving roller 8a.

The primary transfer rollers 8Y, 8M, 8C, and 8K are disposed on the inner periphery of the intermediate transfer belt 8 at the positions opposite to their respective photosensitive drums 9 of the cartridges 7Y, 7M, 7C, and 7K, with the intermediate transfer belt 8 sandwiched therebetween. A primary transfer portion (a primary transfer nip) is formed between each of the primary transfer rollers 8Y, 8M, 8C, and 8K and the intermediate transfer belt 8.

The transfer roller 12 is disposed on the outer periphery of the intermediate transfer belt 8 at the position opposite to the driving roller 8a (a secondary transfer inner roller), with the intermediate transfer belt 8 sandwiched therebetween. A secondary transfer portion T2 (a secondary transfer nip) is formed between the transfer roller 12 and the intermediate transfer belt 8.

The fixing section 4 includes a rotating member pair 16 forming a nip portion (a fixing nip), and a heat source for heating the image on the sheet S at the nip portion. Each of the rotating members constituting the rotating member pair 16 may be any of a cylindrical roller, a tubular thin film, and a belt stretched around a plurality of rollers. As the heat source, for example, a halogen lamp that emits radiant heat, a ceramic heater in which a pattern of heat generating resistors is printed on a ceramic board, or a coil unit that generates an alternating magnetic field for causing a conductive layer in the rotating members to generate heat by an induction heating method can be used.

The printer 1 includes a pickup roller 13, a separation roller pair 14, a registration roller pair 15, a discharge roller pair 17, a reverse roller pair 17A, and double-sided printing roller pairs 201 and 202. In the present embodiment, the pickup roller 13, the separation roller pair 14, the registration roller pair 15, the discharge roller pair 17, and the reverse roller pair 17A are supported by the apparatus main body 1A, and the double-sided printing roller pairs 201 and 202 are supported by the door 20.

In addition, a main conveyance path P1 and the double-sided printing path P2 are formed in the printer 1. The main conveyance path P1 is a conveyance path from the cassette 2 to the discharge tray 5 via the separation roller pair 14, the registration roller pair 15, the secondary transfer portion T2, the fixing nip, and the discharge roller pair 17. The double-sided printing path P2 is a conveyance path that branches off from the main conveyance path P1 downstream of the fixing section 4 in the sheet conveyance direction of the main conveyance path P1 and merges with the main conveyance path P1 upstream of the registration roller pair 15. The reverse roller pair 17A and the double-sided printing roller pairs 201 and 202 are disposed on the double-sided printing path P2.

At least a portion of the double-sided printing path P2 is provided in the door 20. In the present embodiment, as illustrated in FIG. 4, a part of the double-sided printing path P2 including the section between the double-sided printing roller pairs 201 and 202 is provided in the door 20, and the remaining part of the double-sided printing path P2 is provided in the apparatus main body 1A. The main conveyance path P1 or the double-sided printing path P2 may be formed between a guide portion provided on the apparatus main body 1A and a guide portion provided on the door 20.

The pickup roller 13 is a feeding member for feeding the sheets S from the cassette 2. The separation roller pair 14 forms a separation nip, and conveys the sheets S fed by the pickup roller 13 while separating the sheets S one by one at the separation nip. The separation roller pair 14 includes a conveyance roller that conveys the sheet S in a sheet conveyance direction and a separation roller that is in contact with the conveyance roller. The separation roller is a separation member that is supported by a fixed shaft via a torque limiter, for example, and applies a frictional force in a direction opposite to the sheet conveyance direction to the sheet S at the separation nip. The separation roller is an example of a separation member, and for example, a pad-shaped elastic member (a separation pad) may be used as the separation member. Further, the pickup roller 13 and the separation roller pair 14 are an example of a feeding unit that feeds the sheets S one by one. For example, a feeding unit for attracting and conveying the sheets S one by one to an endless belt member may be used.

The registration roller pair 15 is a conveyance roller pair that is disposed upstream of the secondary transfer portion T2 in the sheet conveyance direction and adjacent to the secondary transfer portion T2. That is, the individual sheet S fed from the registration roller pair 15 directly reaches the secondary transfer portion T2 without passing through another roller pair. The discharge roller pair 17 is a discharge unit that discharges a sheet S to the outside of the apparatus main body 1A. The reverse roller pair 17A is a reverse unit that reverses a sheet S when images are formed on both sides of the sheet S. In the present embodiment, the discharge unit and the reverse unit are separately provided. However, one conveyance roller pair serving as both the discharge unit and the reverse unit may be provided.

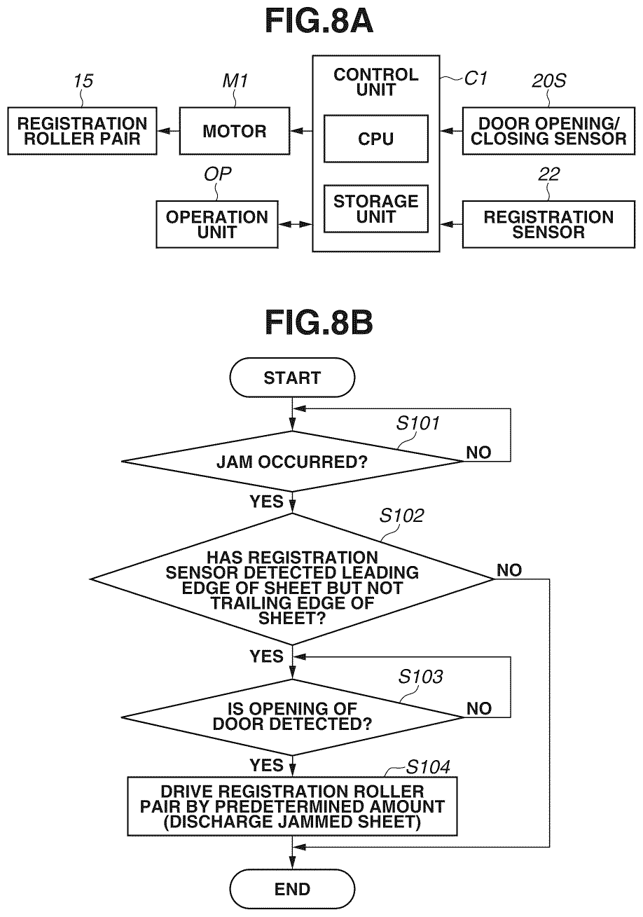

The printer 1 further includes a control unit C1 that controls the operation of the printer 1, a door opening/closing sensor 20S, a registration sensor 22, and an operation unit OP (FIG. 8A). The control unit C1 includes a CPU as an execution unit that executes a program, and a storage unit that stores the program and provides a work space for the CPU. The door opening/closing sensor 20S is a detection unit (an opening/closing detection unit) for detecting opening and closing of the door 20. As the door opening/closing sensor 20S, for example, a switch that is activated by being pressed by the door 20 when the door 20 is at the closed position may be used. The registration sensor 22 will be described below.

The operation unit OP includes a display unit for presenting visual information or audio information to the user and an input unit for the user to input setting information or instructions to the printer 1. Examples of the display unit include a liquid crystal panel and a speaker. Examples of the input unit include physical buttons such as soft keys and ten keys displayed on the liquid crystal panel.

### Image Forming Operation

Next, an image forming operation, which is a series of operations in which the printer 1 forms an image on a sheet S while conveying the sheets S one by one, will be described. The control unit C1 (FIG. 8A) of the printer 1 starts the image forming operation when receiving an image forming instruction (a print instruction) together with image data from an external computer, for example.

When the image forming operation is started, the photosensitive drums 9 in the cartridges 7Y to 7K and the intermediate transfer belt 8 are rotated at a predetermined peripheral surface speed. Each charging roller 10 uniformly charges the surface of its corresponding photosensitive drum 9 with a predetermined polarity and potential. The laser scanner 6 is driven by a video signal generated by the control unit C1 based on the image data, and emits a laser light to the surface of each photosensitive drum 9 for exposure. As a result, electrostatic latent images corresponding to their respective component images derived from color separation of the image data into yellow, magenta, cyan, and black channels are formed on the surfaces of the respective photosensitive drums 9. These electrostatic latent images are developed into single-color toner images in yellow, magenta, cyan, and black by corresponding toner supplied to the photosensitive drums 9 by the developing rollers 11.

The single-color toner images formed on the respective photosensitive drums 9 are primarily transferred to the intermediate transfer belt 8 by the primary transfer rollers 8Y, 8M, 8C, and 8K. In this operation, multiple transfers are performed such that the single-color toner images are superimposed on one another on the intermediate transfer belt 8. In this way, a full-color toner image (hereinafter, simply referred to as “image”) is formed on the intermediate transfer belt 8. The image formed on the intermediate transfer belt 8 is conveyed to the secondary transfer portion T2 by the rotation of the intermediate transfer belt 8 driven by the driving roller 8a.

In parallel with the electrophotographic process performed in the image forming section 3, the sheets S are fed one by one from the cassette 2 to the secondary transfer portion T2. Specifically, the pickup roller 13 comes into contact with the uppermost sheet S in the cassette 2 and feeds the uppermost sheet S to the separation roller pair 14. The separation roller pair 14 conveys the uppermost sheet S and applies the frictional force to the sheets S other than the uppermost sheet S at the separation nip. In this way, the separation roller pair 14 prevents the sheets S other than the uppermost sheet S from passing through the separation nip. Having passed through the separation nip, the sheet S is skew-corrected by the registration roller pair 15, and the sheet S is conveyed to the secondary transfer portion T2 by the registration roller pair 15 in synchronization with the timing at which the image on the intermediate transfer belt 8 reaches the secondary transfer portion T2.

At the secondary transfer portion T2, the image is transferred from the intermediate transfer belt 8 to the sheet S by the voltage application to the transfer roller 12. The sheet S having passed through the secondary transfer portion T2 is conveyed to the fixing section 4, and the image is fixed to the sheet S. In the fixing process, the toner image on the sheet S is heated and pressed while the rotating member pair 16 nips and conveys the sheet S at the fixing nip. The sheet S having passed through the fixing section 4 is guided to either the discharge roller pair 17 or the reverse roller pair 17A by a switching member (not illustrated).

In a case of single-sided printing, the sheet S is guided to the discharge roller pair 17, discharged to the outside of the apparatus main body 1A by the discharge roller pair 17, and stacked on the discharge tray 5. In a case of double-sided printing, after an image is formed on a first surface of the sheet S by causing the sheet S to pass through the secondary transfer portion T2 and the fixing section 4, the sheet S is guided to the reverse roller pair 17A, and conveyed through the double-sided printing path P2. The reverse roller pair 17A switches back the sheet S. The double-sided printing roller pairs 201 and 202 convey the sheet S switched back by the reverse roller pair 17A to the registration roller pair 15. Next, while the sheet S is conveyed from the registration roller pair 15 through the main conveyance path P1 again, an image is formed on a second surface of the sheet S. The sheet S having the image on the second surface is guided to the discharge roller pair 17, discharged to the outside of the apparatus main body 1A by the discharge roller pair 17, and stacked on the discharge tray 5.

### Registration Roller Pair

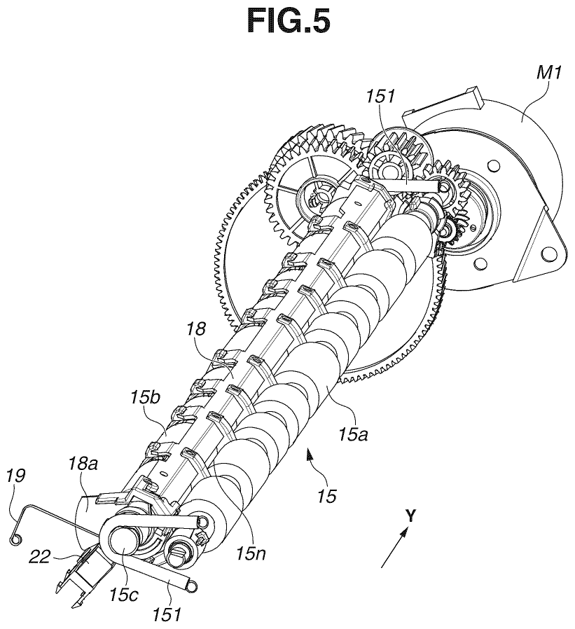

A configuration of the registration roller pair 15 according to the present embodiment will be described with reference to FIG. 5. The registration roller pair 15 is a conveyance roller pair that forms a nip portion 15n and conveys the sheet S nipped by the nip portion 15n in a sheet conveyance direction Dc. The sheet conveyance direction Dc is a moving direction of the sheet S at the nip portion 15n during image formation.

As illustrated in FIG. 5, the registration roller pair 15 includes a driving roller 15a and a driven roller 15b. The driving roller 15a is connected to a motor M1, which is a drive source, via a gear train, and is rotated by the driving force of the motor M1. The driven roller 15b forms the nip portion 15n together with the driving roller 15a, and is rotatable by the driving roller 15a.

The driving roller 15a and the driven roller 15b are pressed by the biasing force of biasing members. In the present embodiment, nip pressing springs 151 as the biasing members are attached to both ends of a roller shaft 15c of the driven roller 15b, and the driven roller 15b is pressed against the driving roller 15a.

A registration shutter 18 is disposed near the registration roller pair 15. The registration shutter 18 is rotatable about the roller shaft 15c of the driven roller 15b. The registration shutter 18 includes a sheet contact portion that can protrude upstream of the nip portion 15n of the registration roller pair 15 in the sheet conveyance direction Dc. The registration shutter 18 is biased by a shutter spring 19 in a direction (a clockwise direction in the drawing) in which the sheet contact portion protrudes upstream of the nip portion 15n.

During the image formation, the leading edge of the sheet S conveyed from the separation roller pair 14 or the double-sided printing roller pair 202 to the registration roller pair 15 comes into contact with the sheet contact portion of the registration shutter 18. As a result, the sheet S is bent, and the skew feeding of the sheet S is corrected such that the leading edge of the sheet S follows the registration shutter 18. When the pressing force from the sheet S exceeds the biasing force of the shutter spring 19, the registration shutter 18 is rotated such that the sheet contact portion is retracted downstream of the nip portion 15n, which allows the sheet S to enter the nip portion 15n. In this way, for example, when the sheet S stored in the cassette 2 is obliquely set or when the sheet S is inclined at the separation roller pair 14, the skew of the sheet S can be corrected.

The method using the registration shutter 18 is an example of a skew correction method. The skew correction may be performed by causing the leading edge of the sheet S to come in contact with the nip portion 15n of the registration roller pair 15 in a stopped state without using the registration shutter 18.

Further, a registration sensor 22 as a detection unit for detecting the sheet S is provided near the registration roller pair 15. The registration sensor 22 according to the present embodiment is configured to generate a signal based on the position of the registration shutter 18. Specifically, the registration sensor 22 is a transmissive optical sensor (photo-interrupter) that is blocked by a flag 18a provided at an end portion of the registration shutter 18.

The registration sensor 22 can detect that the registration shutter 18 is rotated by a sheet S. That is, during the period from when the leading edge of the sheet S reaches the nip portion 15n of the registration roller pair 15 to when the trailing edge of the sheet S passes through the nip portion 15n, the registration sensor 22 is in a state of outputting a first signal (a detection state). Before the leading edge of the sheet S reaches the nip portion 15n of the registration roller pair 15 and after the trailing edge of the sheet S passes through the nip portion 15n, the registration sensor 22 is in a state of outputting a second signal (a non-detection state).

During the image formation, the rotation speed of the motor M1 is controlled based on the signal from the registration sensor 22 such that the timing at which the image on the intermediate transfer belt 8 reaches the secondary transfer portion T2 synchronizes with the timing at which the sheet S enters the secondary transfer portion T2. In this way, the alignment of the image with the sheet S (registration) is performed.

### Jam Clearing Process

A configuration relating to the jam clearing process will be described. The jam clearing process refers to a process performed when a sheet S is jammed (conveyance abnormality) during the image formation and the user removes the sheet S remaining inside the printer 1 (hereinafter, this sheet may be referred to as a jammed sheet).

The control unit C1 of the printer 1 (FIG. 8A) monitors the conveyance of the sheet S based on detection signals of the sensors disposed along the conveyance paths (P1, P2) of the sheet S, and detects occurrence of a jam, for example, when a delay exceeding an allowable range of a planned schedule occurs. For example, in a case where the registration sensor 22 does not return to the non-detection state even when a predetermined time has elapsed from the time at which the registration sensor 22 is switched from the non-detection state to the detection state, the control unit C1 determines that a jam has occurred and the sheet S remains at the registration roller pair 15 or somewhere downstream of the registration roller pair 15.

When the occurrence of a jam has been detected, the control unit C1 interrupts the image forming operation and stops the conveyance of the sheet S, and also notifies the user of the occurrence of the jam through a screen display or a voice message via the operation unit OP. The content of the notification may include the position of the jammed sheet and the procedure for removing the jammed sheet.

As illustrated in FIGS. 2 and 4, the printer 1 includes a transfer guide 21. The transfer guide 21 includes a guide portion that forms a part of the main conveyance path P1. The transfer guide 21 and the transfer roller 12 are a part of a transfer guide unit 21U rotatably supported by the apparatus main body 1A via a fulcrum 21a.

The transfer guide 21 is movable between a closed position (a first position) and an open position (a second position). As illustrated in FIG. 3, the closed position of the transfer guide 21 is a position at which at least a part of the sheet conveyance path (the main conveyance path P1) downstream of the registration roller pair 15 in the sheet conveyance direction Dc of the registration roller pair 15 is formed. As illustrated in FIGS. 2 and 4, the open position of the transfer guide 21 is a position at which at least a part of the sheet conveyance path (the main conveyance path P1) downstream of the registration roller pair 15 is opened. According to the present embodiment, when the transfer guide 21 is opened, the section from the registration roller pair 15 to a position immediately before the fixing section 4 in the main conveyance path P1 is opened. The transfer guide 21 is movable between the closed position and the open position in the state where the nip portion 15n of the registration roller pair 15 is formed.

Hereinafter, the closed position and the open position of the door 20 will be referred to as a first closed position and a first open position, and the closed position and the open position of the transfer guide 21 will be referred to as a second closed position and a second open position, to distinguish these positions.

The door 20 and the transfer guide 21 can be opened when the user performs the jam clearing process or the like.

The door 20 is rotated about the fulcrum 20a from the first closed position to the first open position. The transfer guide 21 is rotated about the fulcrum 21a from the second closed position to the second open position.

When the door 20 is opened, at least a part of the double-sided printing path P2 is exposed to the outside of the printer 1. As a result, the user can easily remove the jammed sheet remaining in the double-sided printing path P2.

When the door 20 is opened and the transfer guide 21 is opened, at least a part of the main conveyance path P1 is exposed to the outside of the printer 1. According to the present embodiment, when the door 20 and the transfer guide 21 are opened, the section from the registration roller pair 15 to the vicinity of the upstream side of the fixing section 4 in the main conveyance path P1 is exposed to the outside of the printer 1. As a result, the user can easily remove the jammed sheet remaining in the main conveyance path P1. That is, when the door 20 and the transfer guide 21 are opened, the opening of the apparatus main body 1A is exposed to allow the access to the jammed sheet.

In particular, according to the present embodiment, when the door 20 is opened and the transfer guide 21 is opened, the nip portion 15n of the registration roller pair 15 becomes visible from the outside of the printer 1 (FIG. 2). Therefore, when a jam has occurred while the leading edge of the sheet S protrudes downstream of the nip portion 15n, the user can perform the jam clearing process by pinching the leading-edge portion of the jammed sheet and pulling out the jammed sheet from the registration roller pair 15.

According to the present embodiment, the transfer guide 21 is configured to move from the second closed position to the second open position in conjunction with the movement of the door 20 from the first closed position to the first open position. For example, the transfer guide 21 moves from the second closed position to the second open position by its own weight when the door 20 is opened, and is held at the second closed position by being pressed by the door 20 when the door 20 is closed.

The present disclosure is not limited to this configuration. The door 20 and the transfer guide 21 may be connected by a link member, and the transfer guide 21 may be configured to move in conjunction with opening and closing of the door 20 by transmission of force via the link member. Alternatively, the transfer guide 21 may be configured not to move in conjunction with the opening and closing of the door 20. The user may manually move the transfer guide 21 from the second closed position to the second open position after the door 20 is opened.

### Jam Clearing Process on Sheet Stopped Near Registration Roller Pair

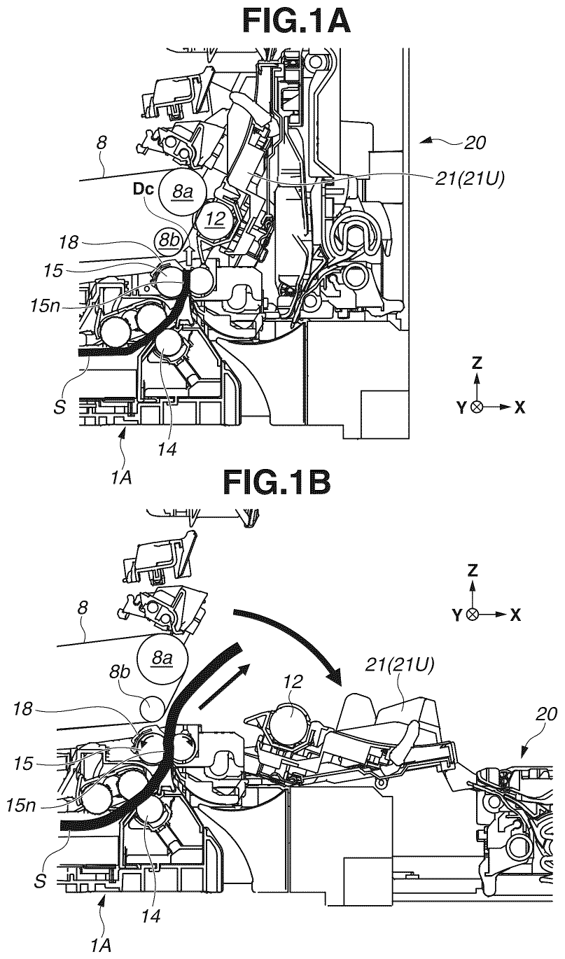

When a jam occurs while the leading edge of the sheet S is located downstream of and near the registration roller pair 15 as illustrated in FIG. 1A, the jam clearing process could become difficult. That is, in a case where the leading edge of a jammed sheet is located downstream of and near the registration roller pair 15, the user may have difficulty in pinching the jammed sheet due to the interference of the registration roller pair 15. Further, since the intermediate transfer belt 8 is present near the leading edge of the jammed sheet, the work space is limited, and the jam clearing process could become even more difficult.

Thus, when the transfer guide 21 is opened in a state where the sheet S is detected to be present at the registration roller pair 15, the control unit C1 according to the present embodiment performs a moving operation of moving the sheet S downstream in the sheet conveyance direction Dc by driving the registration roller pair 15.

The printer 1 according to the present embodiment has the door opening/closing sensor 20S for detecting opening and closing of the door 20, and the transfer guide 21 is opened/closed in conjunction with the opening and closing of the door 20. Therefore, the control unit C1 according to the present embodiment determines that the transfer guide 21 is opened based on the signal from the door opening/closing sensor 20S, and executes the moving operation. That is, the door opening/closing sensor 20S is an example of a detection unit that outputs different signals for a state where the transfer guide 21 is at the closed position (the first position) and for a state where the transfer guide 21 is at the open position (the second position). Alternatively, the detection unit may be a sensor that directly detects the position of the transfer guide 21, such as a switch that is activated by being pressed by the transfer guide 21.

FIG. 8B is a flowchart illustrating a procedure of a process relating to the moving operation. In step S101, the control unit C1 monitors occurrence of a jam during the execution of the image forming operation. If a jam occurs (YES in step S101), the process proceeds to step S102. In step S102, the control unit C1 stops the rotation of the motor M1 to stop the conveyance of the sheet S, and determines the position of the jammed sheet. If the registration sensor 22 is in a detection state at the time of the occurrence of the jam, that is, if the registration sensor 22 has already detected the passage of the leading edge of the sheet S but not the passage of the trailing edge of the sheet S (YES in step S102), the control unit C1 determines that the moving operation is desired. In this case, the process proceeds to step S103. In step S103, the control unit C1 maintains the stopped state of the motor M1 until the door 20 is opened, and if the opening of the door 20 is detected based on the signal from the door opening/closing sensor 20S (YES in step S103), the process proceeds to step S104. In step S104, the control unit C1 activates the motor M1 to execute the moving operation.

If the registration sensor 22 is in the non-detection state when the jam has occurred, that is, if the registration sensor 22 has not yet detected the passage of the leading edge of the sheet S or if the registration sensor 22 has detected the passage of the trailing edge of the sheet S (NO in step S102), the control unit C1 determines that the moving operation is not needed, and ends the present process.

In the moving operation in step S104, the control unit C1 drives the registration roller pair 15 in the same rotational direction as during the image formation, and moves the jammed sheet downstream in the sheet conveyance direction Dc (FIG. 1B). In this way, the user can remove the jammed sheet more easily. If the control unit C1 determines that the jammed sheet has been moved by a predetermined distance from its position at the time of the occurrence of the jam, the control unit C1 stops the motor M1 and ends the moving operation. The predetermined distance is determined by the amount of rotation of the registration roller pair 15 in the moving operation (the moving distance on the peripheral surface of the driving roller 15a).

The predetermined distance according to the present embodiment is set to a value longer than the distance from the nip portion 15n of the registration roller pair 15 to the upper end portion of the driving roller 8a (for example, 50 mm). In other words, the predetermined distance is longer than the distance from the nip portion to the end portion of the opposing roller (the driving roller 8a), which is located opposite to the transfer roller 12 in the sheet conveyance direction Dc. Therefore, for example, when the moving operation is performed in a state where the leading edge of the jammed sheet is located in the nip portion 15n of the registration roller pair 15, the leading edge of the jammed sheet protrudes downstream of the portion of the intermediate transfer belt 8, the portion being supported by the driving roller 8a, in the sheet conveyance direction Dc. By setting the predetermined distance as described above, the user can perform the jam clearing process in a wider working space without being hindered by the intermediate transfer belt 8.

According to the present embodiment, the stopped state of the motor M1 is maintained until the door 20 and the transfer guide 21 are opened. Maintaining the stopped state of the motor M1 until the door 20 is opened can prevent the intermediate transfer belt 8, etc. from being damaged by the jammed sheet forcibly moved in the moving operation while the door 20 and the transfer guide 21 are closed.

The registration roller pair 15 is configured to convey the sheet S upward. Therefore, when the registration roller pair 15 conveys the jammed sheet while the transfer guide 21 is at the open position, the jammed sheet is bent by its own weight, and the leading edge of the jammed sheet is less likely to reach the intermediate transfer belt 8.

The intermediate transfer belt 8 has an inclined surface that is inclined with respect to the horizontal direction and faces downward in the vertical direction. The inclined surface of the intermediate transfer belt 8 faces the outside of the apparatus main body 1A, and is exposed to the outside of the apparatus main body 1A when the door 20 and the transfer guide 21 are opened. According to the present embodiment, the inclined surface is located between the driving roller 8a and the roller (the assist roller 8b) adjacent to the driving roller 8a. In addition, the inclined surface is located immediately above the nip portion 15n of the registration roller pair 15. The registration roller pair 15 conveys the sheet S such that the sheet S comes into contact with the inclined surface of the intermediate transfer belt 8. Even if the registration roller pair 15 conveys the jammed sheet while the transfer guide 21 is at the open position and even if the leading edge of the jammed sheet comes in contact with the inclined surface of the intermediate transfer belt 8, the leading edge of the jammed sheet S is guided to the outside of the apparatus main body 1A.

As described above, in the present embodiment, in a case where a jam occurs while the sheet S is nipped by the registration roller pair 15, when the transfer guide 21 is moved from the closed position (the first position) to the open position (the second position), the moving operation (in step S104) is executed. The motor M1 (the drive source) and the control unit C1 according to the present embodiment are an example of a moving unit configured to perform the moving operation. In other words, the image forming apparatus according to the present embodiment includes a moving unit configured to perform the moving operation. Specifically, in a state where the conveyance of the sheet is stopped after the leading edge of the sheet has passed through the nip portion and before the trailing edge of the sheet passes through the nip portion, when a conveyance guide is moved from the first position to the second position, the moving unit performs the moving operation of moving the sheet downstream in the sheet conveyance direction with the conveyance roller pair.

Since the moving operation moves the jammed sheet downstream of the registration roller pair 15, the leading-edge portion of the jammed sheet is easily pinched. Thus, in the configuration including the conveyance guide (the transfer guide 21) that can open and close at least a part of the conveyance path downstream of the conveyance roller pair, the workability of the jam clearing process can be improved.

That is, the present embodiment can provide a sheet conveyance apparatus and an image forming apparatus that can improve the workability of the jam clearing process.

### Relationship With Cassette Pull-out Direction

In particular, in the printer 1 according to the present embodiment, the pickup roller 13 (the feeding unit) feeds the individual sheet S downstream in the pull-out direction D1 of the cassette 2 (FIG. 3). With this configuration, for example, reversely rotating the registration roller pair 15 in the moving operation to push back the jammed sheet upstream in the sheet conveyance direction Dc does not improve the workability of the jam clearing process.

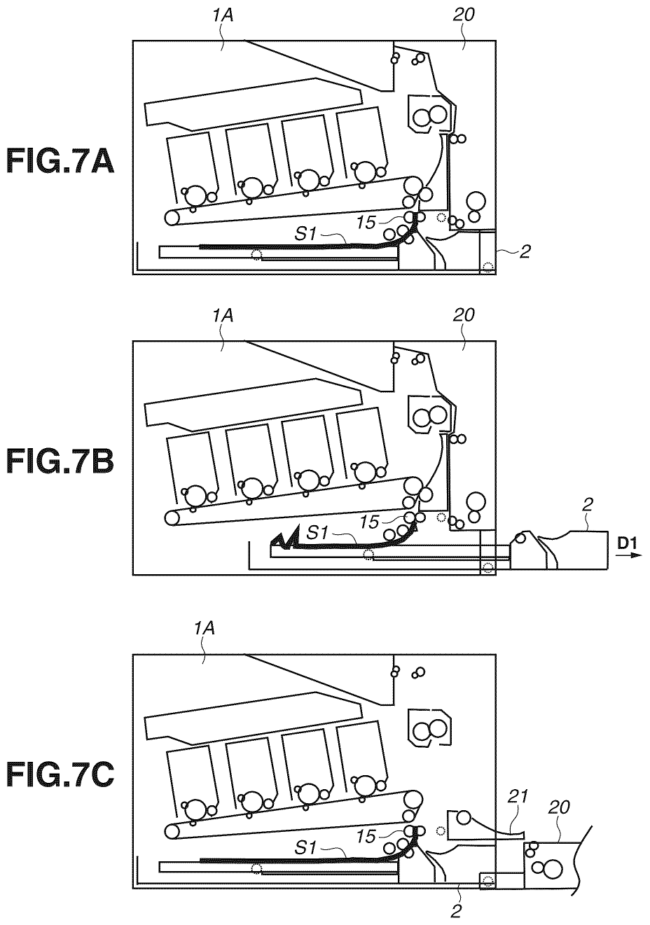

This will be described in detail with reference to FIGS. 7A to 7C. FIG. 7A is a schematic view illustrating the printer 1 in a case where a jam has occurred while the sheet S is nipped by the registration roller pair 15. FIG. 7B is a schematic view illustrating a state where the registration roller pair 15 has been reversely rotated from the state illustrated in FIG. 7A and the cassette 2 has been pulled out from the apparatus main body 1A. FIG. 7C is a schematic view illustrating a state where the registration roller pair 15 has been rotated in the same direction as during the image formation from the state illustrated in FIG. 7A and the door 20 and the transfer guide 21 have been opened.

As illustrated in FIG. 7B, when the cassette 2 is pulled out from the apparatus main body 1A in the state where a jammed sheet S1 is pushed back to the cassette 2 side by reversely rotating the registration roller pair 15, the trailing-edge portion of the jammed sheet S1 may be buckled by being pushed by the cassette 2. Even if the cassette 2 is pulled out fully from the apparatus main body 1A until its limit or the cassette 2 is detached from the apparatus main body 1A, the jammed sheet S1 remains in the apparatus main body 1A, and it is difficult to access the jammed sheet S1 under low visibility. Therefore, the workability of the jam clearing process is not improved in the configuration in which the sheet S is fed downstream in the pull-out direction D1 of the cassette 2, even if the jammed sheet S1 is pushed back upstream of the registration roller pair 15 by the moving operation.

In contrast, as illustrated in FIG. 7C, according to the present embodiment, the sheet S is fed downstream in the pull-out direction D1 of the cassette 2, and the transfer guide 21 located downstream of the registration roller pair 15 can be opened and closed. In this case, by moving the jammed sheet S1 downstream of the registration roller pair 15 by the moving operation, the visibility and the accessibility of the jammed sheet S1 can be improved when the transfer guide 21 is opened. Therefore, the moving operation according to the present embodiment is particularly effective in the configuration in which the sheet S is fed downstream in the pull-out direction D1 of the cassette 2.

### Modification

According to the first embodiment, the door 20 and the transfer guide 21 rotate around the fulcrums 20a and 21a, respectively, and the transfer guide 21 is opened and closed in conjunction with the opening and closing of the door 20. However, the transfer guide 21 (the conveyance guide) may be provided in the door 20. That is, the “conveyance guide” may be a part of an opening/closing member that can open and close the opening portion 1o of the apparatus main body 1A.

In addition, according to the first embodiment, the predetermined distance, which is the setting value for the jammed sheet moving distance in the moving operation (S104), is set to 50 mm. However, the predetermined distance may be changed in accordance with the specific configuration of the printer 1. Further, the registration roller pair 15 may be driven continuously, for example, until the trailing edge of the jammed sheet is discharged from the registration roller pair 15 in the moving operation (S104), without setting the jammed sheet moving distance in the moving operation (S104).

### Second Embodiment

A second embodiment of the present disclosure will be described. The present embodiment differs from the first embodiment in that the present embodiment uses an interlocking mechanism for rotating the registration roller pair 15 in conjunction with the opening of the transfer guide 21. Hereinafter, unless otherwise described, elements denoted by the same reference characters as those in the first embodiment basically have the same configurations and operations as those described in the first embodiment, and the differences from the first embodiment will be mainly described.

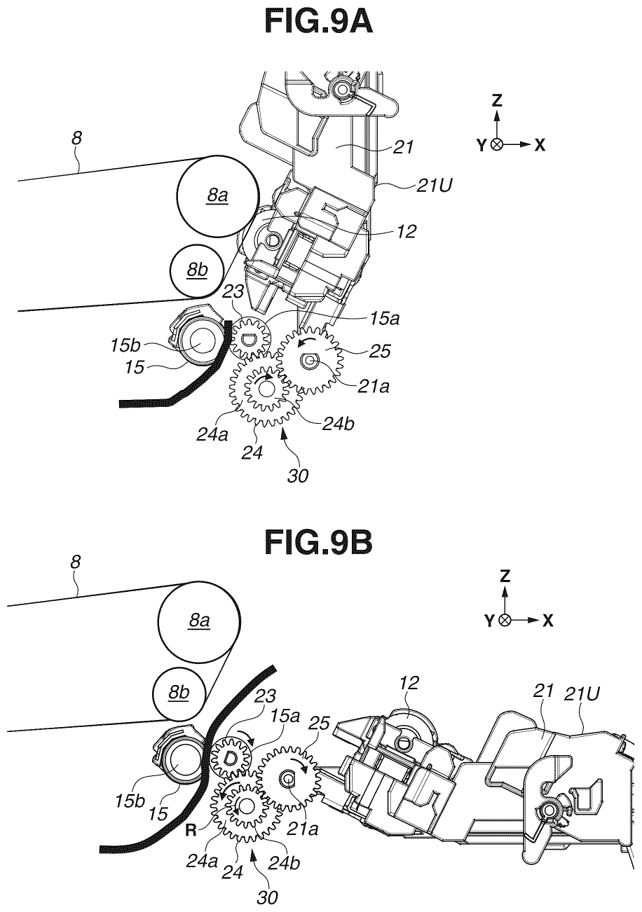

FIGS. 9A and 9B are each a schematic view illustrating an interlocking mechanism 30 according to the present embodiment. FIG. 9A illustrates a state in which the transfer guide 21 is at the closed position, and FIG. 9B illustrates a state in which the transfer guide 21 is at the open position.

As illustrated in FIGS. 9A and 9B, the interlocking mechanism 30 is connected to the transfer guide 21 (the conveyance guide) and the registration roller pair 15 (the conveyance roller pair). The interlocking mechanism 30 can transmit force from the transfer guide 21 to the registration roller pair 15 such that the registration roller pair 15 rotates in conjunction with the movement of the transfer guide 21 from the closed position (the first position) to the open position (the second position). The interlocking mechanism 30 according to the present embodiment includes a roller gear 23, a stepped gear 24, and a transfer guide gear 25.

The roller gear 23 is attached to an end portion of the roller shaft of the driving roller 15a and rotates together with the driving roller 15a. The stepped gear 24 includes a large gear 24a that meshes with the roller gear 23, and a small gear 24b that has a smaller diameter than the large gear 24a. The transfer guide gear 25 meshes with the small gear 24b and rotates about the fulcrum 21a together with the transfer guide 21. When the transfer guide 21 is moved from the closed position to the open position, the transfer guide gear 25 rotates in the clockwise direction in the drawing. When the transfer guide 21 is moved from the open position to the closed position, the transfer guide gear 25 rotates in the counterclockwise direction in the drawing.

A one-way clutch as a blocking unit is incorporated in the stepped gear 24. The one-way clutch rotates the large gear 24a together with the small gear 24b when the small gear 24b is rotated in a predetermined direction indicated by an arrow R in FIG. 9B. The one-way clutch idles when the small gear 24b is rotated in the direction opposite to the predetermined direction, and does not transmit the force from the small gear 24b to the large gear 24a. The predetermined direction is the rotational direction of the small gear 24b when the transfer guide 21 is moved from the open position to the closed position.

That is, the stepped gear 24 incorporating the one-way clutch is an example of the blocking unit that blocks the transmission of force from the transfer guide 21 to the registration roller pair 15 (the conveyance roller pair) when the transfer guide 21 (the conveyance guide) is moved from the open position (the second position) to the closed position (the first position). Alternatively, an electromagnetic clutch may be used as the blocking unit, for example.

The operation of the interlocking mechanism 30 in the jam clearing process will be described. As illustrated in FIG. 9A, assuming that a jam has occurred while the sheet S is nipped by the registration roller pair 15, when the user opens the door 20 for the jam clearing process, the transfer guide 21 rotates in the clockwise direction in the drawing in conjunction with the movement of the door 20, and moves from the closed position to the open position (FIG. 9B). The transfer guide gear 25 rotates along with the rotation of the transfer guide 21, and the transfer guide gear 25 rotates the small gear 24b of the stepped gear 24. Further, the large gear 24a rotates along with the small gear 24b, and the large gear 24a rotates the roller gear 23 in the clockwise direction in the drawing. Next, the driving roller 15a rotates along with the roller gear 23. As a result, the registration roller pair 15 is rotated in the same rotational direction as that during the image formation in conjunction with the movement of the transfer guide 21 from the closed position to the open position. Thus, the jammed sheet is moved downstream of the registration roller pair 15.

That is, the interlocking mechanism 30 transmits force from the transfer guide 21 to the registration roller pair 15 such that the registration roller pair 15 (the conveyance roller pair) is rotated in conjunction with the movement of the transfer guide 21 (the conveyance guide) from the closed position (the first position) to the open position (the second position).

When the user closes the door 20 after the jam clearing process, the transfer guide 21 moves from the open position to the closed position in conjunction with the movement of the door 20 (FIG. 9A). In this case, although the transfer guide gear 25 and the small gear 24b of the stepped gear 24 rotate together with the transfer guide 21, the large gear 24a does not rotate due to the idling of the one-way clutch. Thus, the door 20 and the transfer guide 21 can be closed without rotating the registration roller pair 15. In this way, inconveniences such as an increase in the operation load of the door 20 due to the resistance from the registration roller pair 15 and wear of the rollers due to unnecessary rotation of the registration roller pair 15 can be avoided.

The interlocking mechanism 30 is an example of the moving unit configured to perform the moving operation. Specifically, in a case where a jam has occurred while the sheet is nipped by the conveyance roller pair, when the conveyance guide is moved from the first position to the second position, the interlocking mechanism 30 performs the moving operation of moving the sheet downstream in the sheet conveyance direction with the conveyance roller pair.

Since the jammed sheet is moved downstream of the registration roller pair 15 by the moving operation, the leading-edge portion of the jammed sheet is easily pinched. Therefore, the workability of the jam clearing process can be improved in the configuration including the conveyance guide (the transfer guide 21) that can open and close at least a part of the conveyance path downstream of the conveyance roller pair.

That is, the present embodiment can provide a sheet conveyance apparatus and an image forming apparatus that can improve the workability of the jam clearing process.

Further, the workability of the jam clearing process can be particularly improved in the configuration in which the sheet S is fed downstream in the pull-out direction D1 of the cassette 2.

In addition, according to the first embodiment, suitably, the motor M1 drives only the registration roller pair 15 at least during the jam clearing process such that other driving members are not driven while the motor M1 drives the registration roller pair 15 in the moving operation during the jam clearing process. That is, suitably, a drive source for driving members (for example, the fixing section 4 and the driving roller 8a) other than the registration roller pair 15 in the printer 1 may be provided separately from the motor M1, or a clutch may be used to block the transmission of the driving force from the motor M1 to driving members other than the registration roller pair 15. In contrast, according to the present embodiment, it is not necessary to separately provide a drive source for the registration roller pair 15 and a drive source for driving members other than the registration roller pair 15, or to provide a clutch that blocks the transmission of the driving force to driving members other than the registration roller pair 15. Therefore, for example, in the configuration in which the registration roller pair 15 and driving members other than the registration roller pair 15 are driven by a single motor, the workability of the jam clearing process can be improved at low cost without adding a motor or the like.

The interlocking mechanism 30 including the gear train described in the present embodiment is merely an example, and for example, a belt transmission device or a cam mechanism may be used as the interlocking mechanism. The interlocking mechanism may be any mechanism, as long as the mechanism transmits force from the transfer guide 21 (the conveyance guide) to the registration roller pair 15 (the conveyance roller pair) and rotates the registration roller pair 15 in conjunction with the opening of the transfer guide 21.

### Modifications

In the embodiments described above, the image forming section 3 is merely an example of an image forming unit for forming images on the sheets S. The image forming unit may be a direct-transfer-type electrophotographic unit in which an image is directly transferred from the photosensitive drums 9 as image bearing members onto a sheet S without using the intermediate transfer member.

The image forming unit may be an image forming unit other than the electrophotographic image forming unit, and may be, for example, an inkjet image forming unit.

In the embodiments described above, the present technology is applied to the registration roller pair 15, which is an example of the conveyance roller pair. However, the same technology as that of the embodiments may be applied to another conveyance roller pair. For example, in a configuration in which a sheet S fed from the cassette 2 is sequentially passed through one or more relay roller pairs and conveyed to the registration roller pair 15, assume that a jam has occurred while the sheet S is nipped by any one of the relay roller pairs. In this case, when the conveyance guide forming at least a part of the sheet conveyance path downstream of the relay roller pair is opened, the moving operation of moving the jammed sheet downstream in the sheet conveyance direction can be performed by rotating the relay roller pair.

In the embodiments described above, the sheet conveyance apparatus is incorporated in the printer 1 (the image forming apparatus). However, the sheet conveyance apparatus may be an apparatus separate from the printer 1 (the image forming apparatus). For example, the sheet conveyance apparatus may be a large-capacity feeding apparatus (an option feeder) that is connected to the image forming apparatus and feeds the sheets S to the image forming apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC), or the like) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure can provide a sheet conveyance apparatus and an image forming apparatus that can improve the workability of a jam clearing process.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-157526, filed Sep. 11, 2024, which is hereby incorporated by reference herein in its entirety.

What is claimed is:

1. A sheet conveyance apparatus comprising:
a conveyance roller pair configured to form a nip portion, the conveyance roller pair configured to convey a sheet nipped at the nip portion in a sheet conveyance direction; and
a conveyance guide configured to be movable between a first position and a second position, wherein the conveyance guide at the first position forms at least a part of a sheet conveyance path downstream of the conveyance roller pair in the sheet conveyance direction, and at least a part of the sheet conveyance path is opened in a state where the conveyance guide is at the second position,
wherein the conveyance roller pair is disposed upstream of a transfer portion where an image is transferred from an image bearing member to a sheet and is adjacent to the transfer portion in the sheet conveyance direction, and
wherein, in a case where conveyance of a sheet is stopped after a leading edge of the sheet passes through the nip portion and before a trailing edge of the sheet passes through the nip potion, and where the conveyance guide is moved from the first position to the second position, a moving operation of moving the sheet downstream in the sheet conveyance direction is performed by the conveyance roller pair.

2. The sheet conveyance apparatus according to claim 1, further comprising:
a drive source configured to drive the conveyance roller pair; and
a control unit configured to control the drive source and execute the moving operation.

3. The sheet conveyance apparatus according to claim 2, further comprising:
a detection unit configured to output a signal, the signal being different between a state where the conveyance guide is at the first position and a state where the conveyance guide is at the second position,
wherein the control unit executes the moving operation based on the signals.

4. The sheet conveyance apparatus according to claim 1, further comprising an interlocking mechanism that is connected to the conveyance guide and the conveyance roller pair and transmits force from the conveyance guide to the conveyance roller pair to rotate the conveyance roller pair, in conjunction with movement of the conveyance guide from the first position to the second position.

5. The sheet conveyance apparatus according to claim 4, wherein the interlocking mechanism includes a blocking unit that blocks transmission of the force from the conveyance guide to the conveyance roller pair in a case where the conveyance guide is moved from the second position to the first position.

6. The sheet conveyance apparatus according to claim 1, further comprising:
an apparatus main body configured to support the conveyance roller pair;
a cassette configured to be attached to the apparatus main body and store sheets, the cassette being configured to be pulled out from the apparatus main body in a pull-out direction; and
a feeding unit configured to feed a sheet downstream in the pull-out direction from the cassette,
wherein the conveyance roller pair conveys the sheet fed by the feeding unit.

7. The sheet conveyance apparatus according to claim 6,
wherein the apparatus main body is provided with an opening portion that opens toward a downstream side in the pull-out direction,
wherein the sheet conveyance apparatus further comprises an opening and closing member configured to be movable between a closed position at which the opening portion is closed and an open position at which the opening portion is opened, and
wherein the nip portion of the conveyance roller pair is visible from outside the sheet conveyance apparatus in a state where the opening and closing member is at the open position and the conveyance guide is at the second position.

8. The sheet conveyance apparatus according to claim 1, further comprising:
an apparatus main body configured to support the conveyance roller pair and include an opening portion; and
an opening and closing member configured to be movable between a closed position at which the opening portion is closed and an open position at which the opening portion is opened,
wherein the conveyance guide is configured to move from the first position to the second position in conjunction with movement of the opening and closing member from the closed position to the open position.

9. The sheet conveyance apparatus according to claim 1, wherein, in the moving operation, the conveyance roller pair is stopped after the conveyance roller pair is rotated to move a sheet by a predetermined distance.

10. The sheet conveyance apparatus according to claim 1, further comprising:
an apparatus main body configured to support the conveyance roller pair; and
a transfer roller configured to form the transfer unit between the transfer roller and the image bearing member,
wherein the conveyance guide and the transfer roller are a part of a unit that is rotatable with respect to the apparatus main body.

11. The sheet conveyance apparatus according to claim 10,
wherein, in the moving operation, the conveyance roller pair is stopped after the conveyance roller pair is rotated to move a sheet by a predetermined distance,
wherein the image bearing member is an intermediate transfer belt stretched around a plurality of rollers, and the plurality of rollers include an opposing roller located opposite to the transfer roller, and
wherein the predetermined distance is longer than a distance from the nip portion to a position of an end portion of the opposing roller in the sheet conveyance direction.

12. An image forming apparatus comprising:
the sheet conveyance apparatus according to claim 1; and
an image forming unit configured to form an image on a sheet conveyed by the sheet conveyance apparatus.
